(19) United States
(12) Patent Application Publication
(10) Pub. No.: US 2015/0295875 A1
(43) Pub. Date: Oct. 15, 2015

(54) Automatic Group And Hotspot Creation For Websites

(71) Applicant: Antoine El Daher, Kenmore, WA (US)

(72) Inventor: Antoine El Daher, Kenmore, WA (US)

(21) Appl. No.: 14/248,335

(22) Filed: Apr. 9, 2014

(51) Int. Cl. H04L 12/58; G06F 17/30

(52) U.S. Cl. CPC H04L 51/20; H04L 51/02; G06F 17/30705

(57) ABSTRACT

A method for allowing website servers to automatically generate discussion groups based on currently discussed topics and user locations. In its first embodiment, the server looks for active conversations between users and group posts, clusters the conversations, generates discussion groups from those clusters and then invites the corresponding users to said groups. In another embodiment, the server monitors the users' IP addresses and location, clusters the users by those parameters, generates discussion groups based on them, then invites the corresponding users. In some cases the clustering can be done solely based on IP address so that if multiple people are using the same network to access a site, they will be given a way to converse amongst themselves.

### BACKGROUND

### Non-Patent Literature

“A survey of Text Clustering Algorithms”—C. C. Aggarwal, IBM
“Analysis of user keyword similarity in online social networks”—Bhattacharyya

Traditional websites often allow user of that website to communicate with each other through a messaging system. This is especially frequent in websites that are based around social networking, forums, or blogs. In many of these websites, users may message people they are already connected to or people who are in the same groups as they are.

A group within a social networking site or a forum, is a set of users who share certain characteristics and who have entered said group in order to communicate with other users who may share those characteristics. For example, on a forum site, there may be a group called “Electrical Engineers” which could be joined by electrical engineers and other people interested in electrical engineering, or there may be a group called “New York” which caters to individuals located in New York.

Users who are part of those groups can typically post to these groups. For example, they can create a new discussion topic or express an opinion about an existing topic.

Most of these groups are usually manually created by an individual who later becomes one of the group owners, and then the relevant users are manually invited by the owner or by other existing members of the group. Such a process is typically slow and somewhat ineffective, while requiring a considerable amount of work from the owner.

We use the word website to denote the set of all links contained within the same internet web domain. For example foo.com is a website associated with the URL http://foo.com/user1 or with URL http://mail.foo.com/otherlink/somethingelse. The term website can also be used to refer to a webserver interface accessible only by mobile applications or other applications, in addition to its already understood meaning in the art.

### SUMMARY

This summary is meant to introduce a few concepts in a simplified form that are further described below in the Detailed Description. It is not intended to identify key features or essential features of the claimed subject matter, nor is it intended to be used as an aid in determining the scope of the claimed subject matter.

The premise of this application is that for websites containing discussion groups, it would be useful if there was an automated and simple way to automatically create discussion groups and automatically invite users who would likely be interested.

One embodiment for solving this problem follows: we propose a method by which the server monitors all of the communications and posts of its users across the website, and automatically clusters them into groups to create topical groups, then invites them to continue their discussions on said group.

In a second embodiment, the server monitors the location and IP (Internet Protocol) address of all of its users, and attempts to cluster them into local hotspots, and then invite them to said hotspots, which we may refer to as local groups hereafter. Both the topical groups and the local hotspots need not be permanent groups and may instead be temporary in nature.

We describe several other embodiments in the detailed description and claims.

### Advantages

The advantages of such a system is that it allows users who are talking about similar topics or who are physically located near each other, to communicate with each other directly, by automatically creating groups pertaining to their topic or location, and inviting them to join said groups.

### DRAWINGS

FIG. 1 is a first proposed embodiment, where the groups are automatically created by monitoring the users' conversations and posts.

FIG. 2 shows a second proposed embodiment, where the groups are automatically created by monitoring the users' physical locations and IP addresses.

FIG. 3 shows a third proposed embodiment, where locations and posts are used to automatically create groups.

FIG. 4 describes a basic website networking architecture as it is currently available on the market.

FIG. 5A shows part of the contents of one of the terminals used in FIG. 4.

FIG. 5B shows part of the contents of one of the servers used in FIG. 4.

### DETAILED DESCRIPTION

### First Embodiment

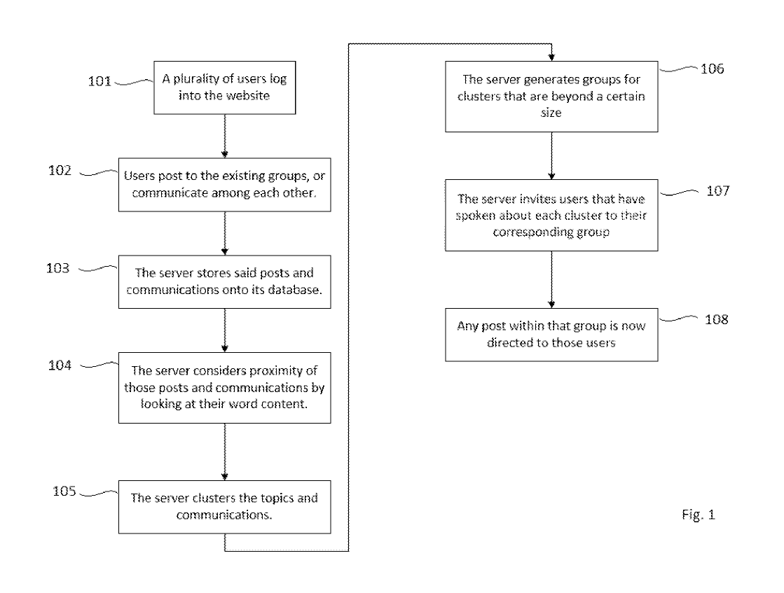

FIG. 1 shows the typical flow of our first embodiment.

In the first step 101, several users log into the website W—it should be understood that those users need not have logged in at the same time. The definition of log in is that which is currently understood in the art.

Throughout their use of the website W, some users may choose to message other users of the website or post topics or comments in groups that they are interested in within the website. This is shown in 102 and is also current understood in the art. A lot of currently existing websites allow for users to send messages to each other, create discussion groups and post topics or comments to said discussion groups. As is the case with those websites, as well as in our own embodiment, the server or servers associated with such websites stores all the communications and posts and comments that the users wrote, into its database, as shown in 103.

Our embodiment differs here from what is typically done in the art. In 104, all the messages, posts and communications, if any, are clustered into groups by the server. The high-level definition of clustered here is to group similar communications together, such that any two pieces of communications within the same group is likely to be seen by a subjective human user as being part of the same topic. The more concrete definition in this embodiment is to treat all these communications as a text document, and then attempt to cluster said documents together using one or more of the methods that are currently in the Art. We have referenced a good survey of currently existing text clustering algorithms by Aggarwal. For example, by using distance-based clustering algorithms described in part 3 of Aggarwal's paper, we can generate clusters of documents that are close to each other, where close to each other means their distance as defined by Aggarwal, is small. At the end of this step 105, the server has now created clusters of communications and posts and comments over all users.

For clusters of documents which are large, the server will choose to generate corresponding groups, provided such groups are not already in existence. To better define everything that was said in this preceding sentence: a server can have a threshold after which clustered groups of similar documents will be considered. In one embodiment, such a threshold is: if more than 1% of all active users within the past month have a conversation, message or post, that ends up being in that cluster, then the cluster is considered to be an interesting topic. Other thresholds are certainly possible—using higher thresholds means that the server is less likely to mark a topic as interesting, and using lower thresholds means a server may mark banal topics as interesting. For those clusters which meet the threshold, the server will generate a separate group, as shown in 106. The group may be given no title in one embodiment, or in another embodiment, it may be given the same title as the most visited article in that cluster. In a third embodiment, the title may be generated automatically by selecting the words in that cluster that appear more frequently than in other clusters. There are many such methods to select a group title and those shouldn't restrict the scope of this application. To check if a group is already in existence, the server may choose to look for groups whose documents ended up forming a significant part of a new cluster—for example, if 50% of the documents that were already in group A ended up in a newly generated group X, the group X has a high likelihood of being nearly a duplicated of A.

Once groups based on popular topics have been created, the server in 107 will proceed to send invitations to the users that participated in said topics and whose documents had been clustered. By doing so, the server is effectively attempting to group together people who may have been communicating about the same thing in different places on the website. The invitations are sent electronically either through the website or using electronic mail or another internet messaging means. The users are notified that there is a group currently discussing their topic and that they can join in if they would like to.

Finally in 108, any users who accept to join that groups effectively are now part of the group, and hence will be notified of communication or posts that happen within the group.

Let us clarify all the above by using an example: let's assume a hypothetical scenario where a new type of battery was invented that has a much higher capacity than normal batteries. On a social networking site or forum, it could be possible that several users are discussing it among each other by sending messages back and forth to each other. It could also be possible that manually created groups like “electrical engineers” or “power engineers” or “environment activists” might be discussing the topic as a group from their perspective and among themselves—for example, the group with most activity may be the electrical engineers group which has a topic called “higher capacity battery”. What the server would do here is notice that there is a big cluster of posts that are related to the same topic, and create a global group called “higher capacity battery”, and then automatically invite all the users and groups who may have mentioned it to join that group, and have the dynamic conversation within it.

Before moving to alternative embodiments, we discuss a bit more about the kind of hardware involved.

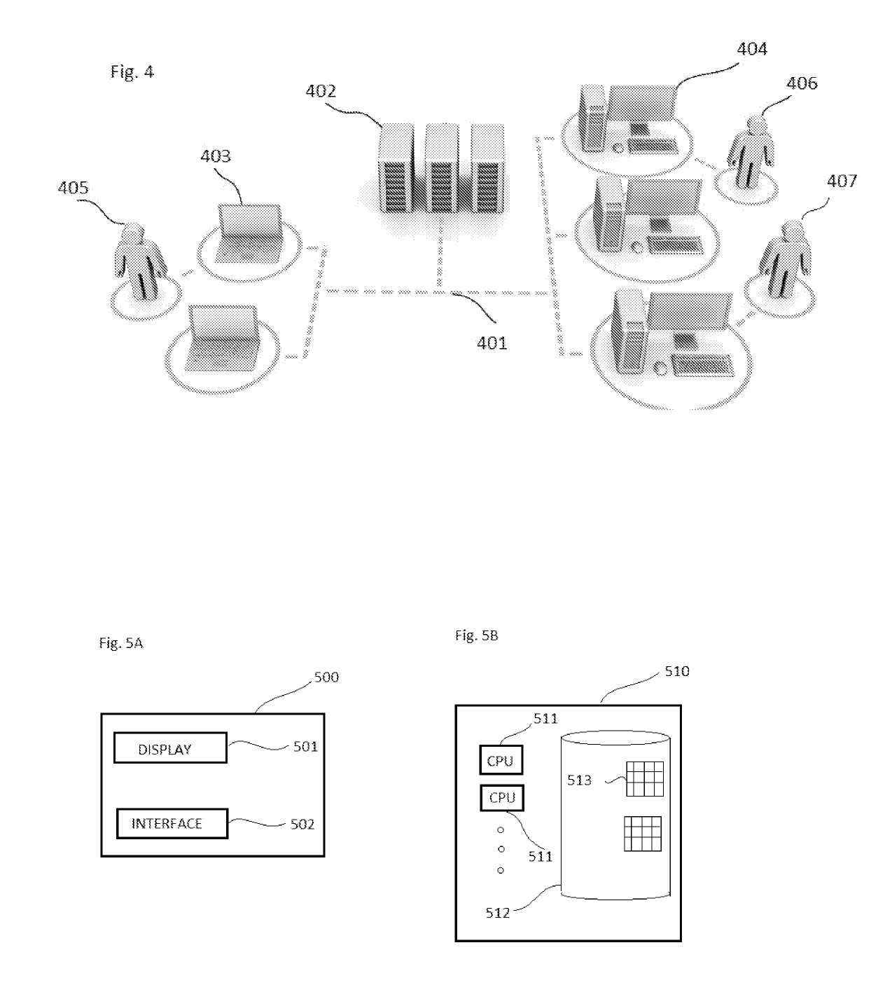

FIG. 4 shows a bit more information pertaining to the hardware involved. Such hardware is currently widespread and well understood and we are bringing it up for the sake of completeness. The method above is meant to run on a computing device such as a computer, server, phone, terminal or other devices. Users such as 405 and 406, through the use of their computing devices or terminals 403 and 404 respectively use the network or internet 401 to connect to one or more servers 402. 401 here could be the currently in-use internet, or a local area network, or a plain telephone system, or a wide area network. For a terminal to connect to the network they can use wired or wireless mediums which may be provisioned with routers and firewalls, but not limited to the above.

A scenario with this architecture would be that user 405 through his use of computing device 403, connects to the server 402 and interfaces with his device to send a message M to user 406. The device in turn relays information over the network 401 and such information is stored on the database of the server. Several other users also send messages to each other, as well as post in groups—all such communications are also stored into the database.

The server then looks through the database and runs the clustering algorithm on all the documents that have been published within a specified number of days—in one embodiment, within the past week, whereas in other embodiments, within the last month, or other specified periods of time. Let's assume that the top cluster found had 1,000 entries (and by entries we mean posts, messages or other communication). Let's assume that M was one such message in the top cluster, and that user 407 independently posted to a group about said topic.

The server would then create a group in its database and invite all users who had entries corresponding to said cluster to join said group, by messaging them through their respective terminals.

FIG. 5A is a diagram showing one embodiment of the terminal used by users. In this embodiment, the terminal 500 comprises a display system 501 as well as an interface 502 that allows its users to interact with it.

FIG. 5B is a diagram showing one embodiment of the server to which the terminals are connecting. The server 510 contains one or more processing units 511, as well as memory 512, which may be made up of one or more databases 513.

The above described the preferred embodiment, but there are several alternate embodiments which are described hereafter.

### Alternative Embodiments

We believe there are several ways to implement the overall system described above. The common factors are that a server handles automatic creation of groups, whether it's by conversation topic, physical location, or IP address.

We note that in the context of this document we may use the term IP and IP address interchangeably depending on the context. Typically a user's IP should be understood to mean a user's IP address where IP stands for Internet Protocol.

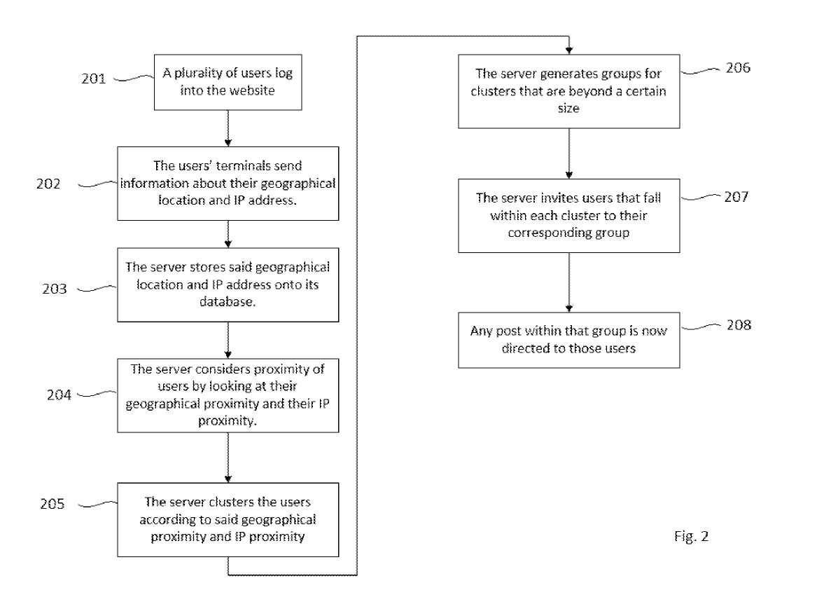

One such embodiment is described in FIG. 2. This embodiment is similar to the one in FIG. 1 except for the criteria used to group users.

As before, a plurality of users log on to the website in 201. They need not log in at the same time.

In 202, the users' terminals are instructed to relay geographical location information and IP address information to the server. The geographical information can be obtained by one or more ways: the first way is for the terminal to prompt the user directly about said user's location; the second way, which applies to mobile devices is to use the built-in GPS position to get the user's location; the third way, is to map the IP address of the terminal to the approximate location based on a database of which internet service provider owns which IP addresses. There are other methods in the art as well and any method which returns a location that is accurate to within at most 20 miles is acceptable here. All the methods described above for getting location are currently already implemented in many modern browsers.

The users' terminals therefore extract location information using the method just described, and send that back to the server along with their IP address. The IP address is typically included in most internet communications and is part of the well understood internet protocol.

In 203, the server thereafter stores the location and IP information about the user into its internal database, mapping users to location/IP.

As was done in the first embodiment, the server now clusters the users—instead of using the content of their messages though, the server uses their location proximity (as measured by the physical distance between their two locations, or variations thereof), and their IP proximity, as measured by how different the two IP addresses are. To better explain the IP address location—let's start with a simple example. If user A has address 55.44.33.22 and user B has address 55.44.33.22 it is quite likely that they are using the same method of accessing the internet. For example, if they are in an airport and connected to the same wireless router, their IPs will typically be identical or differ only slightly. This gives a big hint to the server that these two individuals are actually very close together. If on the other hand, user A has address 55.44.33.22 and user B has address 55.44.77.33, then, even though the users are not at the exact same place, there is some proximity to them since the first parts of their IP address are identical—in this case it could mean that they are within the same state. From hereon, this IP address proximity and the geographical proximity are what the server considers when doing the clustering, as shown in 204.

In 205, the server then runs the clustering algorithm on the locations. Clustering algorithms are well understood in the art for geometric locations. The server also runs a clustering algorithm on IP addresses—in its simplest embodiment, this clustering algorithm for IP addresses just groups together the users who have exactly the same IP. By doing this simple embodiment, all users who are using the same router to connect to the internet are now made part of a group—to be more specific, this means that if there are 100 users of the website currently in an airport and who have the same IP address, all these users would now be part of a group on said website where they can communicate directly to each other. The advantage of this method is that it creates a communication channel between people at the same location, that might otherwise never have existed. The same applies if multiple users are in a restaurant and using its internal wireless connection—the method would allow those users to be put in a group and able to communicate with each other. In another embodiment, IP addresses that are mostly identical can be clustered together as well—in particular, addresses that share the same subnet addresses will be clustered together.

The physical location clustering achieves similar goals to the IP clustering—users who are close to each other get clustered together. The definition of a cluster size can depend on the application, but in one embodiment this size could be restricted to a radius of one mile—i.e. the server would try to generate clusters with radii of one mile and find the one which contains enough users of the site. All the users in that cluster would then be within a mile from each other, and by creating a discussion group for each of them, the server would allow them to communicate with each other.

A third kind of location clustering is simply to combine both the IP clustering and the physical location clustering—in that case the distance between two users can be defined as a weighted sum of the distance between the physical locations and the distance between their IP addresses. We recommend a formula like:

Distance(U1,U2)=0.5×min(1000,Physical Distance(U1,U2))/1000+0.5×min(32,IP Distance(U1,U2))/32

If using IPv4—with IPv6 the number 32 above can be modified. This is just one example of defining the distance and there are many other alternatives that can be used with different weighting factors.
IP Distance between two IPs above can be defined as the difference between a 32-bit representation of IP(U1) and the 32-bit representation of IP(U2) if using IPv4.

Once the users are clustered using IP proximity and geographical proximity, as shown in 205, the groups are automatically created in 206, assuming the cluster size they correspond to has a certain number of users in it—in one embodiment, 5 users could be enough to create a physical location cluster.

As was the case in the first embodiment, the server then automatically invites the users of each cluster to join the generated group in 107. The server in this case may also decide to automatically make the users join their respective groups.

From there on, any post made by those users in their respective groups will be visible to all other users within that same group. Because of the way those groups were made, it means that any posts the user makes would be displayed either to people using the same router as he is (in the case of the IP location clusters), or to the people within a mile or less (using the physical location cluster).

In another embodiment, the server allows users of any group to view the other members in that group. For example, it may be possible for user A to view all users who are within a mile of him, or using the same router as him.

If user A was in a library and using their router to access the internet, by viewing said IP group users he'd be able to see all the people in the library who are on the website.

The advantage here is that it allows users to communicate with other users who are nearby. Being near other users means that there may be more relevant local topics that they can talk about to each other.

In yet another embodiment, groups that are automatically generated by a server may have an expiration time on them—for example, a group created to discuss a topic may be automatically deleted if there is little activity on that topic the next day. More specifically, let's assume that a group was created to discuss a volcano eruption—if that group had less than 10% posts on day 2 than it had on day 1, then it would get automatically deleted in one embodiment.

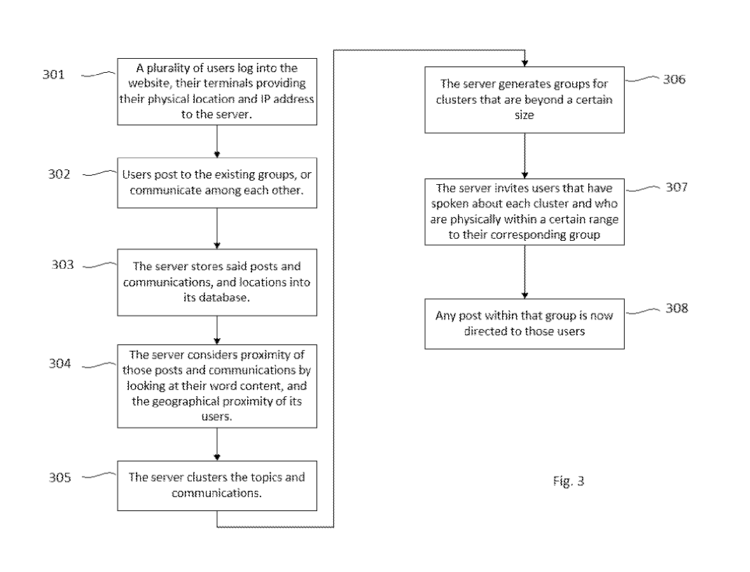

Another hybrid embodiment is detailed in FIG. 3. This one combines the embodiments of FIG. 1 and of FIG. 2 to show that it's indeed possible to have the server automatically create groups based on a plurality of criteria.

As in the previous embodiments, several users log in in 301, with their terminals also sending additional information such as physical location and IP address as was done previous. The users are allowed to then communicate with each other at any time in 302, with said communications and physical addresses and IP addresses stored into the server database in 303. The server then performs clustering which is based on both location and the terms in 304 and 305. Once again there are several ways this can be done—the simplest way, is to do the clustering based on terms as was done in the first embodiment, and then break up said cluster based on location to have several smaller local clusters that talk about the same thing. Another simple embodiment could do the same thing in a different order, first clustering the users based on their location and using a generally large clustering radius (such as 100 miles), and then breaking up the location cluster by topic discussed. It is not hard to see that the clustering can even be improved further by combining the two of them: where a distance between users was previously defined as a geometric and IP distances, now it could be defined as a weighted combination of: geometric distance, IP distance, discussion distance, where discussion distance represents how similar the kinds of conversation that the two users have been having are. There is art that describes said user to user distance in Bhattacharyya's paper—and that can be modified to look at conversations instead of profiles.

For instance, two users who are within 20 miles of each other and who talk about similar things with their friends (i.e. use similar words and concepts) would have a small distance to each other and then could be clustered using any of the methods described above, or even more basic methods such as K-means variant algorithms.

Those clusters of nearby users talking about similar things are then generated and the corresponding users are invited in 306, 307 and 308, as was the case in the previous embodiments.

### CONCLUSIONS, RAMIFICATIONS AND SCOPE

Thus the reader will see that at least one embodiment of the message review system described above will allow servers in websites which support user-to-user communication, to automatically generate groups of users that are more likely to have interesting topics to discuss with each other. Those groups can be based on the users' discussion histories, on their location, or even on their IP address. A server that noticed that 20 people were using the same IP address could easily prompt that: “it looks like 19 other people are using the same IP address as you are, would you like to join their group or view them”.

While the above description contains many specificities, these should not be construed as limitations on the scope but rather as an exemplification of one or several embodiments thereof. Many other variations are possible.

Accordingly, the scope should be determined not by the embodiments illustrated, but by the appended claims and their legal equivalents.

What is claimed is:

1. A computer-implemented method comprising:
receiving a plurality of user communications, each user communication being written by a respective user;
clustering said plurality of user communications into a corresponding plurality of topics;
creating corresponding plurality of discussion groups from said corresponding plurality of topics;
inviting said respective users to said plurality of corresponding discussion groups.

2. The method of claim 1, wherein the inviting step is done through the use of electronic mail.

3. The method of claim 1, further comprising:
deleting discussion group from said plurality of corresponding discussion groups when said discussion group is no longer active.

4. A computer-implemented method comprising:
receiving a plurality of user geographic locations, each location being associated with a corresponding user;
receiving a plurality of user IP addresses, each IP address being associated with a corresponding user;
clustering said users according to said plurality of user geographic locations and said plurality of user IP addresses into a plurality of user clusters;
creating a plurality of a discussion groups corresponding to said plurality of user clusters;
notifying said plurality of users within said plurality of user clusters that said discussion group is available.

5. The method of claim 4, wherein said clustering is done by grouping together users who have the same IP address.

6. The method of claim 5, further comprising:
notifying users whose IP address corresponds to a cluster with more than one user that other users are on the same IP.

7. The method of claim 4, wherein said clustering is performed by using physical distance between two user locations as the cluster distance function.

8. The method of claim 4, wherein said clustering is performed by using a linear combination of physical distance between two user locations, and IP address distance between two users.

9. The method of claim 4, wherein said clustering is performed by using a linear combination of physical distance between two user locations, IP address distance between two users, and communications done by two users.

10. A non-transitory computer-readable medium comprising instructions that, when executed by as processor with memory, are configured to at least:
receive a plurality of requests to store a physical location and IP address, each such request being associated with a user;
store said plurality of physical locations, plurality of IP addresses, and plurality of users associated with said plurality of requests into a database in said memory;
execute a clustering algorithm on said plurality of locations, IP addresses and user;
store resulting clusters returned from said clustering algorithm into said database;
notify said users about said corresponding clusters.

11. The medium of claim 10, wherein said clustering algorithm is done by grouping together users who have the same IP address.

12. The medium of claim 10, wherein said clustering algorithm is based on geographical distance between users.
